(19) United States
(12) Patent Application Publication
(10) Pub. No.: US 2025/0196802 A1
(43) Pub. Date: Jun. 19, 2025

(54) SEATBELT SENSOR CONTROLLER SYSTEM AND METHOD

(71) Applicant: Toyota Material Handling, Inc., Columbus, IN (US)

(72) Inventors: Kaushik Ravichandran, Columbus, IN (US); Maitry Harshel Naik, Columbus, IN (US); Sumit Narang, Columbus, IN (US)

(21) Appl. No.: 18/982,160

(22) Filed: Dec. 16, 2024

Related U.S. Application Data
(60) Provisional application No. 63/611,668, filed on Dec. 18, 2023.

(51) Int. Cl. B60R 22/48

(52) U.S. Cl. CPC B60R 22/48; B60R 2022/4825; B60R 2022/4866

(57) ABSTRACT

A seatbelt sensor controller system and method is provided. The seatbelt sensor controller system includes a seatbelt component and a seatbelt sensor module. The seatbelt sensor module includes: a processor designed to execute instructions stored in a memory module, an electromechanical device for determining a length of a seatbelt strap, and a notification module for notifying an operator of the material handling vehicle if the length of the seatbelt strap is less than a setpoint threshold value.

### BRIEF SUMMARY

This disclosure generally relates to a seatbelt system for a material handling vehicle. More specifically, this disclosure relates to material handling vehicles equipped with a seatbelt sensor controller system configured to detect proper seatbelt usage.

### BACKGROUND

To help ensure an operator's safety while operating a material handling vehicle, like a forklift, it is important to mitigate improper seatbelt usage. Conventional systems often use manual checks and/or audible reminders to enforce proper seatbelt usage, which can be inefficient and ineffective. Operators can often bypass seatbelt interlock to avoid audible seatbelt reminders. An example of an operator bypass is an operator harnessing or securing a seatbelt behind their back. Thus, there exists a need for a more effective seatbelt monitoring system. More specifically, a seatbelt sensor controller system and method for detecting proper seatbelt usage.

### SUMMARY

A seatbelt sensor controller system and method are disclosed. In one aspect, a seatbelt sensor controller system for a material handling vehicle is provided. The seatbelt sensor controller system includes a seatbelt component, and a seatbelt sensor module coupled to the seatbelt component. The seatbelt sensor module includes a processor for executing programmable instructions stored in a memory module, an electromechanical device for determining a length of a seatbelt strap, and a notification module for notifying an operator of the material handling vehicle if the length of the seatbelt strap is less than a setpoint threshold value.

In some embodiments, the seatbelt component includes one or more of the seatbelt strap, a retractor, a latch plate, and a buckle.

In some embodiments, the notification module is configured to notify the operator of the material handling vehicle using tactile feedback, visual feedback, auditory feedback, or a combination thereof.

In some embodiments, the electromechanical device is provided in a form of a rotary encoder or a potentiometer.

In some embodiments, the seatbelt sensor module further comprises a microcontroller, wherein the microcontroller is provided in a form of a single-board microcontroller.

In some embodiments, the seatbelt sensor module further comprises a power supply module, wherein the power supply module is a rechargeable power source.

In another aspect, a method for determining proper engagement of a seatbelt component of a material handling vehicle is disclosed. The method includes determining a vehicle status based on whether the material handling vehicle is ready for operation. The method also includes determining that the material handling device is ready for operation. The method further includes calculating a length of a seatbelt strap, comparing the length of the seatbelt strap to a setpoint threshold value to determine whether the seatbelt strap is properly harnessed, and monitoring the length of the seatbelt strap and the vehicle status.

In some embodiments, determining that the vehicle is ready for operation is based on a detection of an operator being present in a driver's seat of the material handling vehicle. In some embodiments, the method includes sending a first signal if the operator is present and sending a second signal if a determination is made that the seatbelt strap is properly harnessed. In some embodiments, the method also includes sending a third signal if the seatbelt strap is secured in a buckle.

In some embodiments, calculating the length of the seatbelt strap is performed using a sensor, an image processing technique, an electromechanical device, or a combination thereof.

In some embodiments, a determination that the seatbelt strap is properly harnessed occurs if the length of the seatbelt strap is greater than or equal to the setpoint threshold value.

In some embodiments, a determination that the seatbelt strap is improperly harnessed occurs if the length of the seatbelt strap is less than the setpoint threshold value. In some embodiments, the method includes limiting movement of the material handling vehicle after determining the seatbelt strap is improperly harnessed. In other embodiments, the method includes sending a notification that the seatbelt strap is improperly harnessed. In further embodiments, the notification instructs an operator to pull the seatbelt strap an additional length so that a total length of the seatbelt strap is greater than or equal to the setpoint threshold value.

In another aspect, a material handling vehicle is disclosed. The material handling device includes a body having a driver's seat, a shifter module coupled to the body for controlling the material handling vehicle, and a seatbelt sensor controller system operatively coupled to the driver's seat. The seatbelt sensor controller system includes a seatbelt component, wherein the seatbelt component includes a seatbelt strap, and a seatbelt sensor module for determining a length of the seatbelt strap.

In some embodiments, the shifter module limits the speed of the material handling vehicle based on the length of the seatbelt strap.

In some embodiments, the seatbelt sensor module includes a notification module. In other embodiments, the notification module sends a notification if the length of the seatbelt strap is less than a setpoint threshold value.

### BRIEF DESCRIPTION OF DRAWINGS

FIG. 1 is a right side elevational view of a material handling vehicle according to one embodiment;

FIG. 2A is a front and right side isometric view of a driver's seat of the material handling vehicle of FIG. 1 with a seatbelt strap of a seatbelt system engaged according to disclosed embodiments;

FIG. 2B is a front and right side isometric view of the driver's seat of the material handling vehicle of FIG. 1 with a seatbelt strap of a seatbelt system disengaged according to disclosed embodiments;

FIG. 3A is an enlarged isometric view of a seatbelt retractor, the seatbelt strap, and a latch plate of the seatbelt system of FIG. 2B according to disclosed embodiments;

FIG. 3B is an enlarged isometric view of a seatbelt buckle of the seatbelt system of FIG. 2B according to disclosed embodiments;

FIG. 4A is a front and right side isometric view of a seatbelt sensor according to disclosed embodiments;

FIG. 4B is an enlarged isometric view of the seatbelt retractor of the seatbelt system of FIG. 2B with a partial breakaway showing the seatbelt sensor of FIG. 4A enclosed within the seatbelt retractor according to disclosed embodiments;

FIG. 5 is a block diagram of system components of a seatbelt sensor controller system according to disclosed embodiments;

FIG. 6A is a front elevational view of a driver's seat showing proper seatbelt usage while operating the material handling vehicle of FIG. 1 according to disclosed embodiments;

FIG. 6B is a front elevational view of a driver's seat showing improper seatbelt usage while operating the material handling vehicle of FIG. 1 according to disclosed embodiments;

FIG. 6C is a front and right side isometric view of a driver's seat showing improper seatbelt usage while operating the material handling vehicle of FIG. 1 according to disclosed embodiments;

FIG. 7 is a flow diagram of a method of detecting proper seatbelt usage according to disclosed embodiments; and

FIG. 8 is a schematic of a computer system according to an example embodiment of the present disclosure.

### DETAILED DESCRIPTION

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

Before any embodiments of the invention are explained in detail, it is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

As used herein, unless otherwise specified or limited, the terms “mounted,” “connected,” “supported,” and “coupled” and variations thereof are used broadly and encompass both direct and indirect mountings, connections, supports, and couplings. Further, unless otherwise specified or limited, “connected” and “coupled” are not restricted to physical or mechanical connections or couplings.

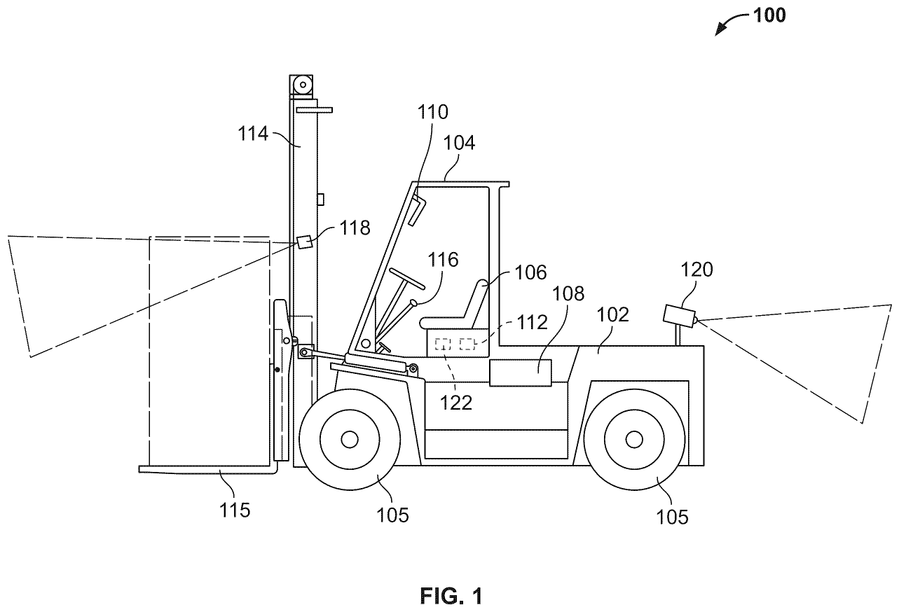

FIG. 1 illustrates a material handling vehicle 100 according to one embodiment. Specifically, a counterbalance-type forklift truck is illustrated, although the systems and processes described herein can be applied to other types of material handling vehicles. The material handling vehicle 100 can include a body 102, an operator cab 104, two or more wheels 105, a driver's seat 106, a processor 108, a display module 110, and a seatbelt sensor controller system 112 to detect improper seatbelt usage. The material handling vehicle 100 can also include a mast 114, a fork 115, a shifter module 116 (e.g., for controlling the direction and speed of the material handling vehicle 100), one or more front facing sensors (e.g., cameras) 118, one or more rear facing sensors (e.g., cameras) 120, and/or one or more feedback devices 122. In some instances, the one or more feedback devices 122 can be configured to alert the operator by auditory, visual, and/or tactile means provided in the form of sirens, horns, announcements, lights, strobes, images, vibrations, deacceleration, and/or pulsations. The feedback devices 122 can, in some instances, display data or an alert on the display module 110. The processor 108, the display module 110, the seatbelt sensor controller system 112, the front facing sensor 118, the rear facing sensor 120, and the one or more feedback devices 122 may be all communicatively coupled to one another and may exchange information via a wired or wireless configuration.

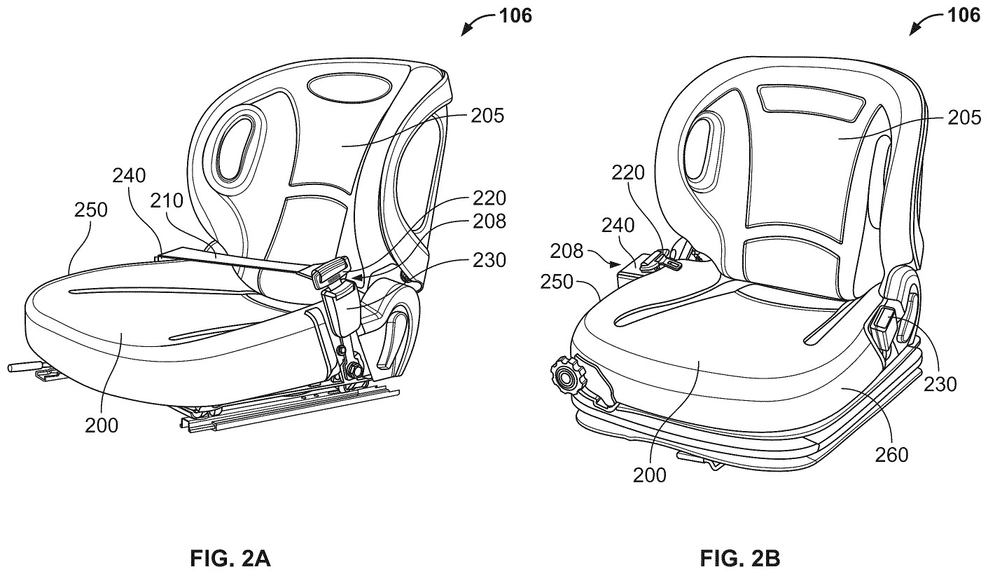

FIGS. 2A and 2B illustrate front and right side isometric views of a driver's seat 106 and a seatbelt strap 210 engaged and disengaged, respectively, according to disclosed embodiments. The driver's seat 106 may include a seat cushion 200 and a back support cushion 205. The driver's seat 106 may be operatively coupled to the seatbelt sensor controller system 112. The seatbelt sensor controller system 112 may include a seatbelt system 208 provided in the form of a seatbelt strap 210, a latch plate 220, a buckle 230, and/or a seatbelt retractor 240. In some embodiments, the seatbelt strap 210 may be housed within the seatbelt retractor 240 in a disengaged state.

As shown in FIGS. 2A and 2B, in some embodiments, the driver's seat 106 may include a first side 250 and a second side 260 that are substantially parallel to one another. In some embodiments, the seatbelt retractor 240, the seatbelt strap 210, and the latch plate 220 are coupled to the first side 250 of the seat cushion 200 of the driver's seat 106, and the buckle 230 may be coupled to the second side 260 of the seat cushion 200 of the driver's seat 106. In other embodiments, the seatbelt retractor 240, the seatbelt strap 210, and the latch plate 220 may be coupled to the second side 260 of the seat cushion 200 of the driver's seat 106, and the buckle 230 may be coupled to a first side 250 of the seat cushion 200 of the driver's seat 106. In further embodiments, one or more of the seatbelt retractor 240, the seatbelt strap 210, the latch plate 220 and the buckle 230 may be coupled to other portions of the driver's seat 106 such as the back support cushion 205.

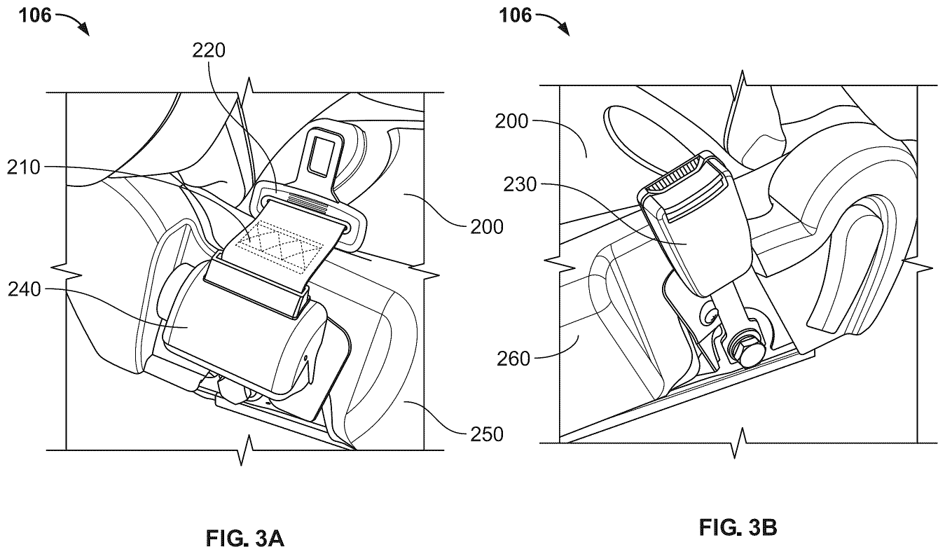

FIG. 3A illustrates an enlarged isometric view of a portion of the first side 250 of the seat cushion 200 of the driver's seat 106 depicting the seatbelt retractor 240, the seatbelt strap 210, and the latch plate 220 coupled to the first side 250 of the seat cushion 200. FIG. 3B illustrates an enlarged side isometric view of a portion of the second side 260 of the seat cushion 200 of the driver's seat 106 showing the buckle 230 coupled to the second side 260 of the seat cushion 200.

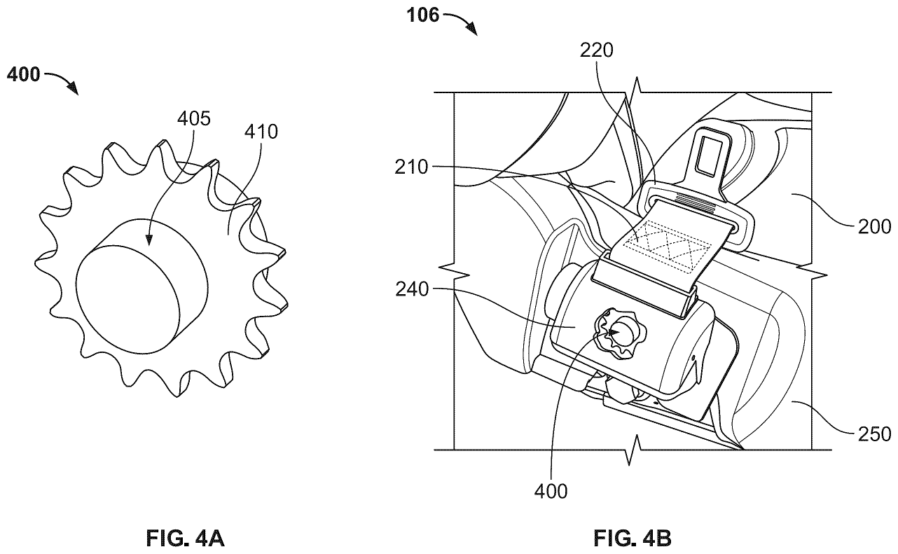

FIG. 4A illustrates an embodiment of a seatbelt sensor 400 which may be used to calculate a length of the seatbelt strap. In some instances, the seatbelt sensor 400 may include a seatbelt sensor module 405 that may be coupled to an attachment member 410. In some embodiments, the attachment member 410 may be provided in the form of a sprocket. In other embodiments, the attachment member 410 may be any size or shape suitable for installation and/or positioning of the seatbelt sensor 400 on or in the seatbelt system 208 or the driver's seat 106. In some instances, the seatbelt sensor 400 may not include an attachment member 410, and the seatbelt sensor module 405 may be directly coupled to the seatbelt system 208 or the driver's seat 106.

FIG. 4B illustrates an enlarged isometric view of a portion of the first side 250 of the seat cushion 200 of the driver's seat 106 with the seatbelt retractor 240. In some embodiments, the seatbelt sensor 400 may be enclosed within the seatbelt retractor 240. In other embodiments, the seatbelt sensor 400 may be operatively coupled to an exterior of the seatbelt retractor 240, or on another suitable location of the seatbelt system 208 or the driver's seat 106.

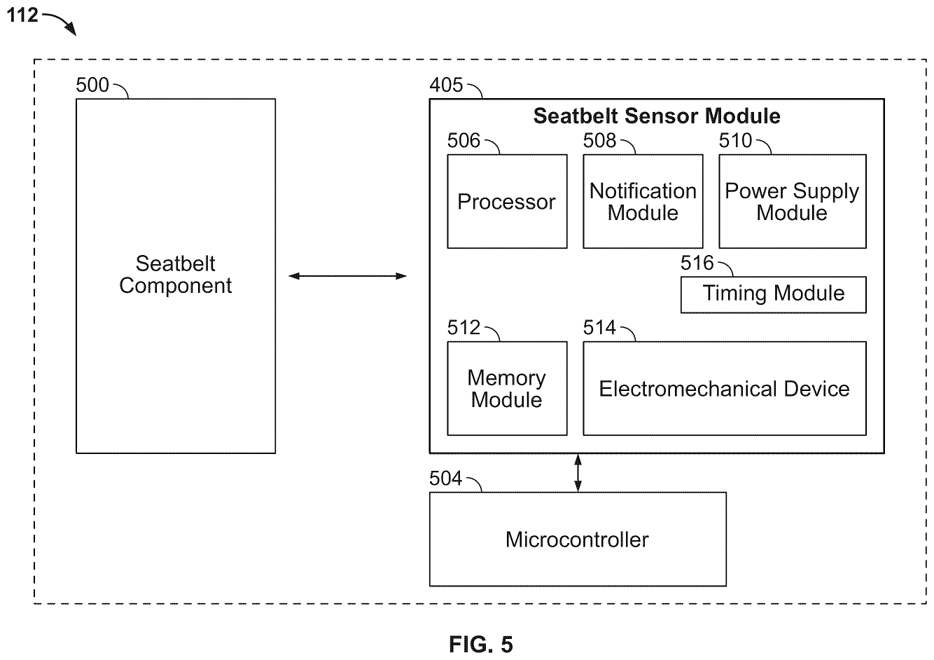

FIG. 5 illustrates a block diagram of system components of the seatbelt sensor controller system 112. The seatbelt sensor controller system 112 may include a seatbelt component 500, the seatbelt sensor module 405, and a microcontroller 504, which may be coupled or otherwise connected to and/or in communication with the seatbelt sensor module 405. The seatbelt component 500 may include one or more of the seatbelt strap 210, the latch plate 220, the buckle 230, and/or the seatbelt retractor 240 of the seatbelt system 208.

In some embodiments, the microcontroller 504 can be provided in the form of a single-board microcontroller. In some embodiments, the microcontroller 504 can be provided in the form of an Arduino, Raspberry Pi, or similar device. In other embodiments, the microcontroller 504 may be omitted.

The seatbelt sensor module 405 can include a seatbelt sensor processor 506, a notification module 508, a power supply module 510, a memory module 512, an electromechanical device 514, and an optional timing module 516, which may all be in electronic communication with each other. The seatbelt sensor processor 506 may be designed or configured to execute programmable instructions that may be stored in the memory module 512. The notification module 508 may be configured to generate and communicate one or more notifications, including the use of haptics, lights, audible warnings, messages, or other types of notifications. In some embodiments, the notification module 508 may send the one or more notifications as one or more signals to the processor 108, one or more feedback devices 122, and/or to the display module 110 of the material handling vehicle 100.

The power supply module 510 can be provided in the form of one or more rechargeable power sources (e.g., a battery). In some embodiments, the power supply module 510 can be operatively coupled to the power supply source for the material handling vehicle 100. The memory module 512 may be designed or configured to store electronic information including instructions and data. The memory module 512 can be provided in the form of one or more memory units, including remotely connected memory banks or devices.

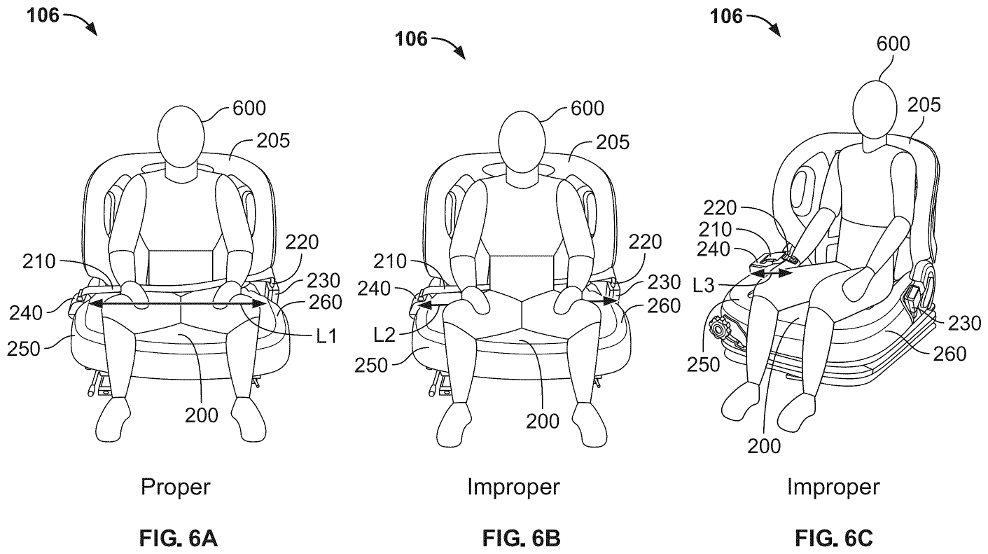

In some embodiments, the electromechanical device 514 can be provided in the form of a rotary encoder, a potentiometer, or similar device to measure or calculate the length of the seatbelt strap 210. In some embodiments, the seatbelt sensor module 405 can include additional electromechanical devices 514, such as a weight sensor, to determine if an operator 600 (see FIGS. 6A, 6B, and 6C) is present at the driver's seat 106. In some embodiments, the weight sensor can be positioned within or underneath the seat cushion 200 of the driver's seat 106. The timing module 516 may be configured or designed to provide a timing component margin.

FIGS. 6A, 6B, and 6C illustrate front and isometric views of the driver's seat 106 with an operator 600 utilizing the seatbelt strap 210 in three different configurations. In one non-limiting example, the operator 600 in FIG. 6A has the seatbelt strap 210 engaged properly, meaning the seatbelt strap 210 is extended across the front of the operator's 600 abdomen and the latch plate 220 is secured in the buckle 230. This may be considered proper seatbelt usage while operating the material handling vehicle 100. The operator 600 in FIG. 6B has the seatbelt strap 210 engaged using the latch plate 220 secured in the buckle 230. However, in this non-limiting example, the operator 600 is wearing the seatbelt strap 210 improperly because the seatbelt strap 210 is extended behind the operator's 600 back instead of across the front over the abdomen. This may be considered improper seatbelt usage while operating the material handling vehicle 100 as it may not protect the operator 600. The configuration in FIG. 6B can be used to disable one or more notifications triggered by conventional systems that only verify whether the latch plate 220 is secured in the buckle 230. The operator 600 in FIG. 6C, in another non-limiting example, has the seatbelt strap 210 disengaged, where the latch plate 220 is not secured in the buckle 230 and the seatbelt strap 210 is not extended across the driver's seat 106 but instead is coiled within the seatbelt retractor 240. This may be improper seatbelt usage while operating the material handling vehicle 100.

The seatbelt sensor controller system 112 improves existing technology by not only determining if the latch plate 220 is engaged with the buckle 230, but also identifying a length of the seatbelt strap 210 and comparing the identified length to a setpoint threshold value corresponding to proper seatbelt usage. In some embodiments, the setpoint threshold may be a minimum length value. For example, if the seatbelt strap length is greater than (or equal to) the minimum length value, then a signal or notification is sent indicating that enough seatbelt length has been pulled, and if the seatbelt strap length is below the minimum length value, then a signal or notification is sent indicating that not enough seatbelt length has been pulled. In other embodiments, the setpoint threshold may include a minimum length value and a maximum length value, where a signal or notification is sent if the seatbelt strap length is less than the minimum length value or the seatbelt strap length is greater than the maximum length value. In some embodiments, the setpoint threshold value may vary based on the type of material handling vehicle 100 or how or for what purpose the material handling vehicle 100 is being used.

In a non-limiting example, an identified first length L1 of the seatbelt strap 210 in FIG. 6A, which may correspond to proper seatbelt usage, is greater than or equal to a setpoint threshold value. First length L1 is longer than an identified second length L2 and a third length L3 of the seatbelt strap 210 shown in FIGS. 6B and 6C, respectively, which correspond to improper seatbelt usage (e.g., L2 and L3 are less than the setpoint threshold value). Although different operators may have different abdomen sizes, the system can identify when the seatbelt component 500 is properly engaged (e.g., the latch plate 220 of the seatbelt strap 210 is secured in the buckle 230) and when the length of the seatbelt strap 210 is greater than or equal to the setpoint threshold for proper usage.

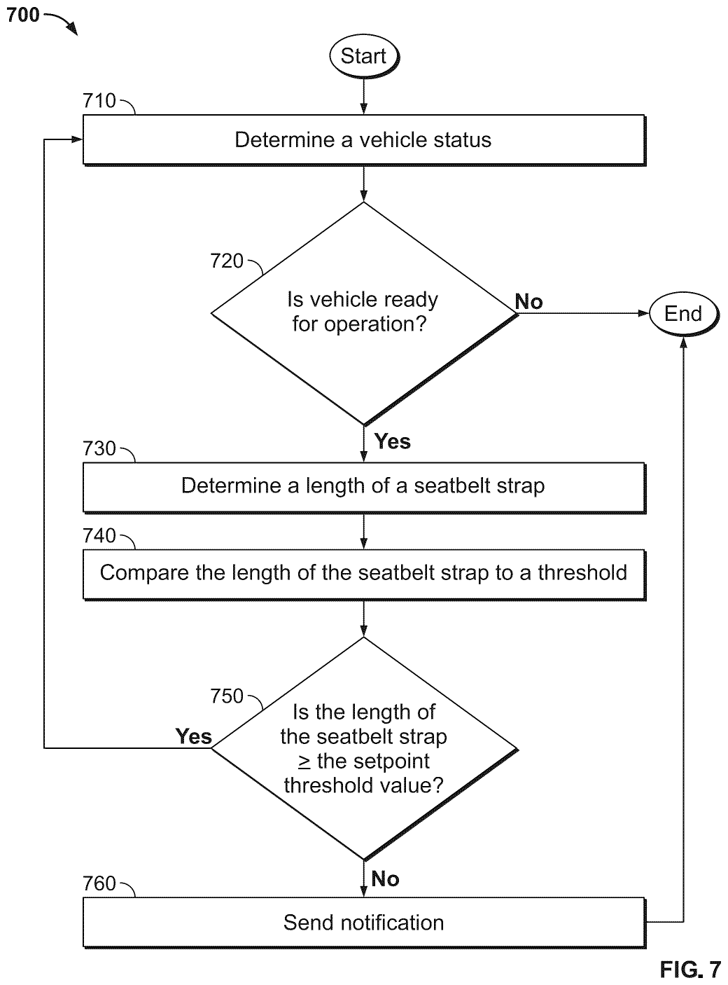

FIG. 7 illustrates an example method of a flow diagram of a method 700 for detecting proper seatbelt usage/harnessing. A system (e.g., seatbelt sensor controller system 112) determines a vehicle status at 710 to determine whether the material handling vehicle 100 is ready for operation. The process for determining the vehicle status can include, but is not limited to, one or more of identifying a state of a vehicle key switch, identifying an operator presence (e.g., via a weight sensor, image processing, motion detection, etc.), identifying an operator authentication (e.g., through an identification badge or card or other identification credential), etc. In some embodiments, a first signal may be sent (or received) by the system indicating that the vehicle is ready for operation at 720. For example, the first signal may be sent when the operator is sitting in the driver's seat 106. In some embodiments, the first signal may be sent by the processor 108. If the material handling vehicle 100 is not ready for operation, then the method ends.

If the material handling vehicle 100 is ready for operation, the system determines a length of the seatbelt strap 210 at 730. In some embodiments, the length of the seatbelt strap 210 may be calculated or determined by the electromechanical device 514. At 740, the system may compare the identified length of the seatbelt strap 210 to a setpoint threshold value to determine whether the seatbelt strap 210 is properly harnessed or improperly harnessed. If the system determines the seatbelt strap 210 is greater than or equal to the setpoint threshold value (e.g., the seatbelt is properly harnessed) at 750, a second signal may be sent (or received) by the system indicating that the operator has pulled enough seatbelt length. In some embodiments, the second signal stays on until the vehicle status changes to an “off” status (e.g., is not ready for operation) or the length of the seatbelt strap falls below (e.g., is less than) the setpoint threshold value. In some instances, a timing component margin may be incorporated to provide an operator time to get comfortable or readjust the seatbelt strap 210 before the seatbelt strap length is determined at 730. For example, the second signal indicating whether enough seatbelt strap length has been pulled may be sent after a certain amount of time (e.g., 1 second, 2 seconds, 3 seconds, 4 seconds, etc.). In some embodiments, a third signal may be sent (or received) by the system at 750 if the seatbelt strap 210 has been secured by placing the latch plate 220 in the buckle 230. Once the first, second, and third signals are sent and/or received by the seatbelt sensor controller system 112, the material handling vehicle 100 may be able to move without restriction. The system may continue to monitor the seatbelt strap 210 length until the vehicle status changes (e.g., the vehicle is turned off, the operator presence is no longer detected, etc.) or the seatbelt strap 210 length falls below the setpoint threshold value.

If the length of the seatbelt strap 210 is less than the setpoint threshold value at 750 (e.g., the operator 600 has improperly harnessed the seatbelt strap 210), then the second signal indicating that enough length has been pulled may not be sent and the system may send a notification via the notification module 508 at 760. The notification module 508 may notify the operator 600 using one or more notification techniques that the seatbelt is improperly harnessed. In some embodiments, if the seatbelt strap 210 is retracted after the seatbelt is buckled, such that the total seatbelt strap length is less than the setpoint threshold value, then the second signal indicating that enough length has been pulled may turn off at 750 and a notification may be sent at 760. In other embodiments, a separate signal indicating that the seatbelt strap has fallen below (e.g., is less than) the setpoint threshold value may be sent in addition to the notification.

The notification technique may include a warning, alert, or other notification. In some instances, the notification may instruct the operator to pull a certain length of the seatbelt strap 210 before the operator buckles the seatbelt strap 210. For example, if the operator pulls the seatbelt strap 210 out X amount, where X amount is less than the setpoint threshold value, the system may instruct the operator to pull the seatbelt out an additional Y amount, so that the total seatbelt strap length pulled (X+Y) is greater than or equal to the setpoint threshold value. Once the total amount pulled is greater than or equal to the setpoint threshold value, then the second signal indicating that enough seatbelt length has been pulled may be sent. In some embodiments, the system may disable operation or limit the speed of the material handling vehicle 100 or may disable or limit the lifting speed of the fork 115 until the seatbelt strap 210 is properly harnessed. When the system detects the seatbelt strap 210 is properly harnessed, the system may monitor the length of the seatbelt strap 210 to identify any changes (e.g., the seatbelt length falls below the setpoint threshold value) until the vehicle status changes. In some embodiments, the determination of the seatbelt strap 210 length at 730 can be identified using one or more sensors, devices, image processing techniques, or other advanced processing techniques.

In further embodiments, a CAN (controller area network) message may be sent to one or more telematics devices for data processing and collections. The CAN message or messages may contain information requesting customer service for troubleshooting purposes. The CAN message or message may also provide seatbelt threshold information. For example, if the material handling vehicle 100 is not operating even when setpoint threshold has been met (e.g., the length of the seatbelt strap 210 is greater than or equal to the setpoint threshold).

In some embodiments, the one or more telematics devices may determine a length of an operator's arm, an average time it takes the operator to pull the seatbelt strap 210 and secure the seatbelt strap in the buckle 230, and/or the average seatbelt strap length for the operator as such data is unique to each operator. Once the data is collected for the operator (e.g., the operator's arm length, the average time it takes the operator to buckle the seatbelt strap 210, and/or the average seatbelt strap length), the data may be compared to an operator's identification profile (e.g., an identification card or badge, identification number, sign-in information or other identification credential) to ensure the operator is the correct person (e.g., the data collected matches the operator's identification profile) operating the material handling vehicle 100. If the comparison is not a match, then the material handling vehicle 100 may have limited or no drivability (e.g., the shifter module 116 may limit the speed of travel of the material handling vehicle 100), the material handling vehicle 100 may have limited or no operability (e.g., movement of the fork 115 may be restricted or prevented), or an alert or other notification may be sent.

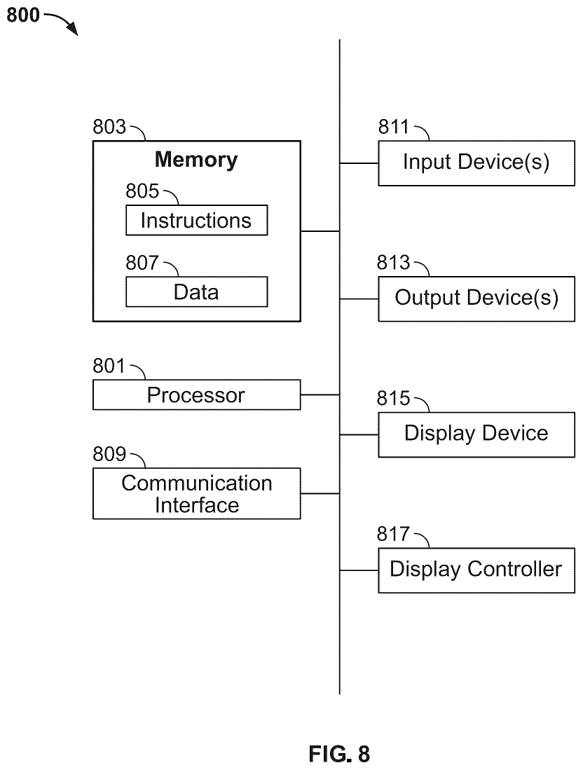

FIG. 8 is a schematic view of an example computer system according to an example embodiment of the present disclosure. FIG. 8 illustrates certain components that may be included within a computer system 800, which may be used to control the systems and methods of FIGS. 1-7. One or more computer systems 800 may be used to implement the various devices, modules, components, and systems described herein.

The computer system 800 may include a processor 801 (e.g., the processor 108, the seatbelt sensor processor 506, the microcontroller 504). The processor 801 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 801 may be referred to as a central processing unit (CPU). Although just a single processor 801 is shown in the computer system 800 of FIG. 8, in an alternative configuration, a combination of processors (e.g., an ARM and DSP) could be used. In one or more embodiments, the computer system 800 further includes one or more graphics processing units (GPUs), which can provide processing services related to both entity classification and graph generation.

The computer system 800 may also include a memory 803 (e.g., the memory module 512) in electronic communication with the processor 801. The memory 803 may be any electronic component capable of storing electronic information. For example, the memory 803 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 805 and data 807 may be stored in the memory 803. The instructions 805 may be executable by the processor 801 to implement some or all of the functionality disclosed herein. Executing the instructions 805 may involve the use of the data 807 that is stored in the memory 803. Any of the various examples of modules and components described herein may be implemented, partially or wholly, as instructions 805 stored in the memory 803 and executed by the processor 801. Any of the various examples of data described herein may be among the data 807 that is stored in memory 803 and used during execution of the instructions 805 by the processor 801.

The computer system 800 may also include one or more communication interfaces 809 for communicating with other electronic devices. The communication interface(s) 809 may be based on wired communication technology, wireless communication technology, or both. Some examples of communication interfaces 809 include a Universal Serial Bus (USB), an Ethernet adapter, a wireless adapter that operates in accordance with an Institute of Electrical and Electronics Engineers (IEEE) 702.11 wireless communication protocol, a Bluetooth® wireless communication adapter, and an infrared (IR) communication port.

The computer system 800 may also include one or more input devices 811 and one or more output devices 813 (e.g., the front facing sensor 118, the rear facing sensor 120, the feedback devices 122, the display module 110). Some examples of input devices 811 include a keyboard, a mouse, a microphone, a remote control device, a button, a joystick, a trackball, a touchpad, and a light pen. Some examples of output devices 813 include a speaker and a printer. One specific type of output device that is typically included in a computer system 800 is a display device 815 (e.g., the display module 110). The display device 815 used with embodiments disclosed herein may utilize any suitable image projection technology, such as liquid crystal display (LCD), light-emitting diode (LED), gas plasma, electroluminescence, or the like. A display controller 817 may also be provided, for converting data 807 stored in the memory 803 into text, graphics, and/or moving images (as appropriate) shown on the display device 815.

The various components of the computer system 800 may be coupled together by one or more buses, which may include a power bus, a control signal bus, a status signal bus, a data bus, etc. For the sake of clarity, the various buses are illustrated in FIG. 8 as a bus system 819.

In other embodiments, other configurations are possible. For example, those of skill in the art will recognize, according to the principles and concepts disclosed herein, that various combinations, sub-combinations, and substitutions of the components discussed above can provide appropriate control for a variety of different configurations of IoT devices, material handling vehicles, work machines, operator control systems, automotive vehicles, consumer electronics, and so on, for a variety of applications. All trademarks used herein are the property of their respective owners.

The previous description of the disclosed embodiments is provided to enable any person skilled in the art to make or use the invention. Various modifications to these embodiments will be readily apparent to those skilled in the art, and the generic principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. A seatbelt sensor controller system for a material handling vehicle, the seatbelt sensor controller system comprising:
a seatbelt component; and
a seatbelt sensor module coupled to the seatbelt component, comprising:
a processor designed to execute programmable instructions stored in a memory module;
an electromechanical device for determining a length of a seatbelt strap; and
a notification module for notifying an operator of the material handling vehicle if the length of the seatbelt strap is less than a setpoint threshold value.

2. The seatbelt sensor controller system of claim 1, wherein the seatbelt component includes one or more of the seatbelt strap, a retractor, a latch plate, and a buckle.

3. The seatbelt sensor controller system of claim 1, wherein the notification module is configured to notify the operator of the material handling vehicle using tactile feedback, visual feedback, auditory feedback, or a combination thereof.

4. The seatbelt sensor controller system of claim 1, wherein the electromechanical device is provided in a form of a rotary encoder or a potentiometer.

5. The seatbelt sensor controller system of claim 1, wherein the seatbelt sensor module further comprises a microcontroller, wherein the microcontroller is provided in a form of a single-board microcontroller.

6. The seatbelt sensor controller system of claim 1, wherein the seatbelt sensor module further comprises a power supply module, wherein the power supply module is a rechargeable power source.

7. A method for determining proper engagement of a seatbelt component of a material handling vehicle, the method comprising:
determining a vehicle status based on whether the material handling vehicle is ready for operation;
determining that the material handling vehicle is ready for operation;
calculating a length of a seatbelt strap;
comparing the length of the seatbelt strap to a setpoint threshold value to determine whether the seatbelt strap is properly harnessed; and
monitoring the length of the seatbelt strap and the vehicle status.

8. The method of claim 7, wherein determining that the vehicle is ready for operation is based on a detection of an operator being present in a driver's seat of the material handling vehicle.

9. The method of claim 8, further comprising sending a first signal if the operator is present and sending a second signal if a determination is made that the seatbelt strap is properly harnessed.

10. The method of claim 9, further comprising sending a third signal if the seatbelt strap is secured in a buckle.

11. The method of claim 7, wherein calculating the length of the seatbelt strap is performed using a sensor, an image processing technique, an electromechanical device, or a combination thereof.

12. The method of claim 7, wherein a determination that the seatbelt strap is properly harnessed occurs if the length of the seatbelt strap is greater than the setpoint threshold value.

13. The method of claim 7, wherein a determination that the seatbelt strap is improperly harnessed occurs if the length of the seatbelt strap is less than the setpoint threshold value.

14. The method of claim 13, further comprising limiting movement of the material handling vehicle after determining the seatbelt strap is improperly harnessed.

15. The method of claim 13, further comprising sending a notification that the seatbelt strap is improperly harnessed.

16. The method of claim 15, wherein the notification instructs an operator to pull the seatbelt strap an additional length so that a total length of the seatbelt strap is greater than the setpoint threshold value.

17. A material handling vehicle comprising:
a body having a driver's seat;
a shifter module coupled to the body for controlling the material handling vehicle; and
a seatbelt sensor controller system operatively coupled to the driver's seat, the seatbelt sensor controller system comprising:
a seatbelt component, wherein the seatbelt component includes a seatbelt strap; and
a seatbelt sensor module for determining a length of the seatbelt strap.

18. The material handling vehicle of claim 17, wherein the shifter module limits the speed of the material handling vehicle based on the length of the seatbelt strap.

19. The material handling vehicle of claim 18, wherein the seatbelt sensor module includes a notification module.

20. The material handling vehicle of claim 19, wherein the notification module sends a notification if the length of the seatbelt strap is less than a setpoint threshold value.
